(19) United States
(12) Patent Application Publication
(10) Pub. No.: US 2006/0075344 A1
(43) Pub. Date: Apr. 6, 2006

(54) Providing assistance

(75) Inventors: Edward K.Y. Jung, Bellevue, WA (US); Royce A. Levien, Lexington, MA (US); Mark A. Malamud, Seattle, WA (US); John D. Rinaldo JR., Bellevue, WA (US)

Correspondence Address: Searete LLC;Suite 110, 1756-114th Ave. S.E., Bellevue, WA, 98004, US

(73) Assignee: Searete LLC, a limited liability corporation of the State of Delaware

(21) Appl. No.: 10/955,966

(22) Filed: Sep. 30, 2004

(51) Int. Cl. G06F 17/00

(52) U.S. Cl. 715/705

(57) ABSTRACT

Methods, devices, and systems that receive a signal corresponding to a selected portion of a manual related to an aspect of an electronic device, and provide an assistance correlating to the selected portion of the manual through a user interface of the electronic device different from the manual.

### SUMMARY

An embodiment provides a method. The method includes receiving a signal corresponding to a selected portion of a manual related to an aspect of an electronic device, and providing an assistance correlating to the selected portion of the manual through a user interface of the electronic device different from the manual. The method may further include searching an assistance file for the assistance correlating to the selected portion of the manual. Searching the assistance file may include searching an assistance file stored in the electronic device. The providing an assistance further may include providing a visual presentation, providing an audio presentation, providing a spoken presentation, and providing a tactile presentation. The assistance may include assistance with a physical element of the device, and the physical element of the device may include blinking a light emitter associated with the physical element. The assistance may include a guidance through a process associated with the aspect of the device. The assistance may include a description of the aspect of the device, showing how the aspect of the device works, and an interactive tutorial. The selected portion of a manual related to an aspect of an electronic device may include a user-selected portion of a manual related to an electronic device. A further embodiment may include a computer-readable media containing computer instructions which, when run on a computer, cause the computer to perform the method. The computer-readable media may include a computer storage media, and the computer storage media may be carried by a computer readable carrier. The computer-readable media may include a communications media. In addition to the foregoing, other methods are described in the claims, drawings, and text forming a part of this document.

Another embodiment provides a method. The method includes receiving a signal corresponding to a selected portion of a manual related to an item having an electronic device, and providing an assistance correlating to the selected portion of the manual through a user interface associated with the electronic device and different from the manual. In addition to the foregoing, other methods are described in the claims, drawings, and text forming a part of this document.

A further embodiment provides a method. The method includes receiving a signal corresponding to a selected portion of a manual related to an item, and providing an assistance correlating with the selected portion of the manual through a user interface of an electronic device removably associated with item. In addition to the foregoing, other methods are described in the claims, drawings, and text forming a part of this document.

Another embodiment provides a system. The system includes an electronic device having an electronic device user interface and including a computing device having a storage media. Also, a manual having a manual user interface and including a content related to the electronic device. The manual is operable to receive a user-selection to a portion of the manual related to an aspect of the electronic device through the manual user interface, and generate a signal corresponding to the user-selected portion of the manual. The system further includes an electronic device assistance manager that includes instructions, that when implemented in a computing device cause the computing device to receive the signal corresponding to a user-selected portion of the manual, and provide an assistance correlating to the user-selected portion of the manual through the electronic device user interface. The electronic device assistance manager further may include an assistance file having an assistance content related to the electronic device. The electronic device may be included in an electrical appliance and the manual may include a content associated with the electrical appliance. The electronic device may be included in a computing device and the manual may include a content associated with the computing device. The computing device may include a personal computer. The electronic device may be a limited resource computing device and the manual may include a content associated with the limited resource computing device. The electronic device may be included in a pervasive computing device and the manual may include a content associated with the pervasive computing device. The electronic device may be included in a digital appliance and the manual may include a content associated with the digital appliance. The manual and the electronic device may be linked by a physical coupling.

The aspect of the electronic device may include a feature of the electronic device, a component of the electronic device, a process associated with the electronic device, and a button of the electronic device. The button may include a tangible button. The manual may include information related to the device, and instructions related to the device. The electronic device user interface may include a visual display, a graphical display, a graphical user interface, and a tactile display. The electronic device user interface may include an audio display, and the audio display may include an acoustic speaker. In addition to the foregoing, other systems are described in the claims, drawings, and text forming a part of this document.

A further embodiment provides system. The system includes an electronic device having an electronic device user interface and includes a computing device having a storage media. The system includes an electronic device assistance manager which includes instructions, that when implement in a computing device cause the computing device to receive a signal corresponding to a user-selected portion of a manual related to an aspect of the electronic device, and provide an assistance correlating to the user-selected portion of the manual through the electronic device user interface. In addition to the foregoing, other systems are described in the claims, drawings, and text forming a part of this document.

An embodiment provides a system. The system includes a computing device having a user interface and a storage media, and a manual having a user interface and including a content related to the computing device. The manual includes operability to receive a user-selection to a portion of the manual related to an aspect of the computing device through the manual user interface, and generate a signal corresponding to the user-selected portion of the manual. The system includes a computing device assistance program which includes instructions, that when implement in a computing device cause the computing device to receive the signal corresponding to a user-selected portion of the manual, and provide an assistance correlating to the user-selected portion of the manual through the electronic device user interface. In addition to the foregoing, other systems are described in the claims, drawings, and text forming a part of this document.

Another embodiment provides a method. The method includes receiving a signal corresponding to a user-selected portion of a manual related to an aspect of an electronic device, the user selection having been received by a user interface of the manual. Also, receiving a signal corresponding to a user-selected request for assistance related to the aspect of the electronic device, the user selection having been received by the user interface of the manual. The method includes searching an assistance file for an assistance correlating to the user-selected request for assistance, and providing the assistance correlating to the user-selected request for assistance through a user interface of the electronic device. The signal corresponding to a user-selected request for assistance may be generated in response to a user selection of an assistance mode from a menu provided by the manual. In addition to the foregoing, other methods are described in the claims, drawings, and text forming a part of this document.

A further embodiment provides a manual. The manual includes a content related an electronic device, a user interface different from the electronic device and operable to receive a user-selection to a portion of the manual content and a module operable to generate a signal corresponding to the user-selected portion of the manual. The operable to receive a user-selection may include operability to receive a user touch, operability to receive a movement of a user body part with respect to the portion of the manual, operability to receive a user created sound, operability to receive a user spoken word or phrase, and operability to receive a user body part orientation with respect to the portion of the manual. The user body part may be a finger, and may be an eye. The manual may include information related to the device, and may include instructions related to the device. The manual may include a tangible manual, and the tangible manual may include a paper manual. The manual may include an e-paper manual. The manual may include an intangible manual, which may include a manual called from a storage, and may include a manual received over the Internet. The manual may include streaming images, and the manual may include an audio stream. In addition to the foregoing, other manuals are described in the claims, drawings, and text forming a part of this document.

An embodiment provides a manual. The manual includes a content related to an item having an electronic device, and a user interface different from the electronic device and operable to receive a user-selection to a portion of the manual content. The manual further includes a module operable to generate a signal corresponding to the user-selected portion of the manual. In addition to the foregoing, other manuals are described in the claims, drawings, and text forming a part of this document.

An embodiment provides a method. The method includes receiving a user-selection to a portion of a manual having a content related to an electronic device in a user interface different from the electronic device, and generating a signal correlating to the user-selected portion of the manual content. The receiving the user-selection may include receiving a signal responsive to a user-selection touch to the portion of the manual. Receiving the user-selection may include receiving a signal responsive to a user body part having an orientation with respect to the portion of the manual. Receiving the user-selection may include receiving a signal responsive to a user created sound. The user-selected portion of the manual may include at least a portion of a page, a word, a picture, and a figure. The user-selected portion of the manual may include a portion of an image stream, and may include a portion of an audio stream. In addition to the foregoing, other methods are described in the claims, drawings, and text forming a part of this document.

Another embodiment provides a method. The method includes receiving a user-selection to a portion of a manual related to an electronic device through a user interface, and generating a signal corresponding to the user-selected portion of the manual. The method includes receiving a user assistance selection in the user interface, and generating a signal corresponding to the user assistance selection. The user assistance selection may be received in a user interface different from the electronic device. In addition to the foregoing, other methods are described in the claims, drawings, and text forming a part of this document.

In addition to the foregoing, various other method and/or system embodiments are set forth and described the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and a review of the associated drawings.

### BRIEF DESCRIPTION OF THE DRAWINGS

FIG. 1 illustrates an exemplary system in which embodiments may be implemented, including a thin computing device and a functional element of an electronic device;

FIG. 2 illustrates another exemplary system in which embodiments may be implemented, including a general-purpose computing device;

FIG. 3 is a flow diagram illustrating an exemplary process;

FIG. 4 is a flow diagram illustrating another exemplary process; and

FIG. 5 illustrates an exemplary system that includes a digital camera and a manual related to the camera.

### DETAILED DESCRIPTION

In the following detailed description illustrating several exemplary embodiments, reference is made to the accompanying drawings, which form a part hereof. In the several figures, like referenced numerals identify like elements. Other embodiments may be utilized, and other changes may be made, without departing from the spirit or scope of the subject matter described here. The following detailed description is therefore not to be taken in a limiting sense, and the scope of the claimed subject matter is defined by the appended claims.

Features, functionality, and options of computing devices, such as personal computers, have rapidly advanced as technology provides increased processor speeds, storage capacity, connectivity, and interconnectivity, all at decreased cost. At the same time, software, programs, games, and procedures have similarly rapidly advanced. Additionally, rapid advances have been made in interconnectability and interoperability of computing devices and other devices, such as handheld devices and cell phones. These advances are intended to provide a user with many benefits. However, realization of these benefits may require that a user read and re-read manuals.

When new, a user may or many not take the trouble to read a manual. Manuals are often considered too complex and troublesome to comprehend. As a result, the advances may be unused and the user dissatisfied. Further, in working with a manual, it is often tedious and confusing to work back and forth between a computer's user interfaces and the manuals, in that user attention must shift back and forth between the computer and its manual. Additional user attention shifting is required when one portion of a manual references another portion of the manual or a different manual. A user may benefit from being able to find a portion of the manual relevant to their need or question, and then let user interfaces of the computer guide them from there.

In addition, as a result of rapidly advancing computer technology, computing devices are become smaller, more powerful, and cheaper. The advancing computing technology is moving beyond the personal computer and into everyday items and devices, providing embedded technology and connectivity. Almost any thing or item, from buildings to clothing, from telephones to tools, from appliances to cars, from homes to the human body, from personal information devices to a common a coffee mug, can have an embedded electronic device that includes a thin computing device. The embedded electronic device typically improves performance and capacity of a basic functionality of the item, and may connect the item with a network of other items or the Internet. Other applications of the rapidly advancing computer technology include electronic devices that include thin computing devices and that perform a computerized functionality. These with embedded electronic devices may be described using a variety of names, which may not have a bright line distinction between them. Commonly used names include a limited resource computing device, limited capacity computing device, ubiquitous computing device, pervasive computing device, digital appliance, and Internet appliance. Such items may be collectively referred to herein from time-to-time as “pervasive computing,” or a “pervasive computing device” for economy of words and to aid in reading and understanding embodiments disclosed herein.

While pervasive computing provides increased performance and capacity, pervasive computing often requires increased interaction between a user and a previously dumb device or item to achieve benefits provided by increased functionality, features, and options. Pervasive computing devices do not include a rich user interface often available on personal computers and other full-blown computing devices. In addition, pervasive computing devices, such as conventional telephones, cell phones, smart phones, pocket organizers, and personal digital assistants, often present a user with widely varying user interface protocols. This may contribute to user confusion about whether a user interface they are viewing, such as a particular button, is the button shown in a manual. As a result, simply finding appropriate aspects of the device related to a portion of the user manual may be difficult or impossible.

Rapidly advancing technology may also provide an opportunity for increased interaction between traditionally dumb items and user manuals. Many dumb items have become more complex and sophisticated to meet consumer demand. For example, simply adjusting an ergonomic chair requires complex instructions and location of knobs placed at odd locations. User manuals have correspondingly become more complex and sometimes confusing. As a result, simply finding appropriate aspects of the item related to a portion of the user manual may be difficult or impossible.

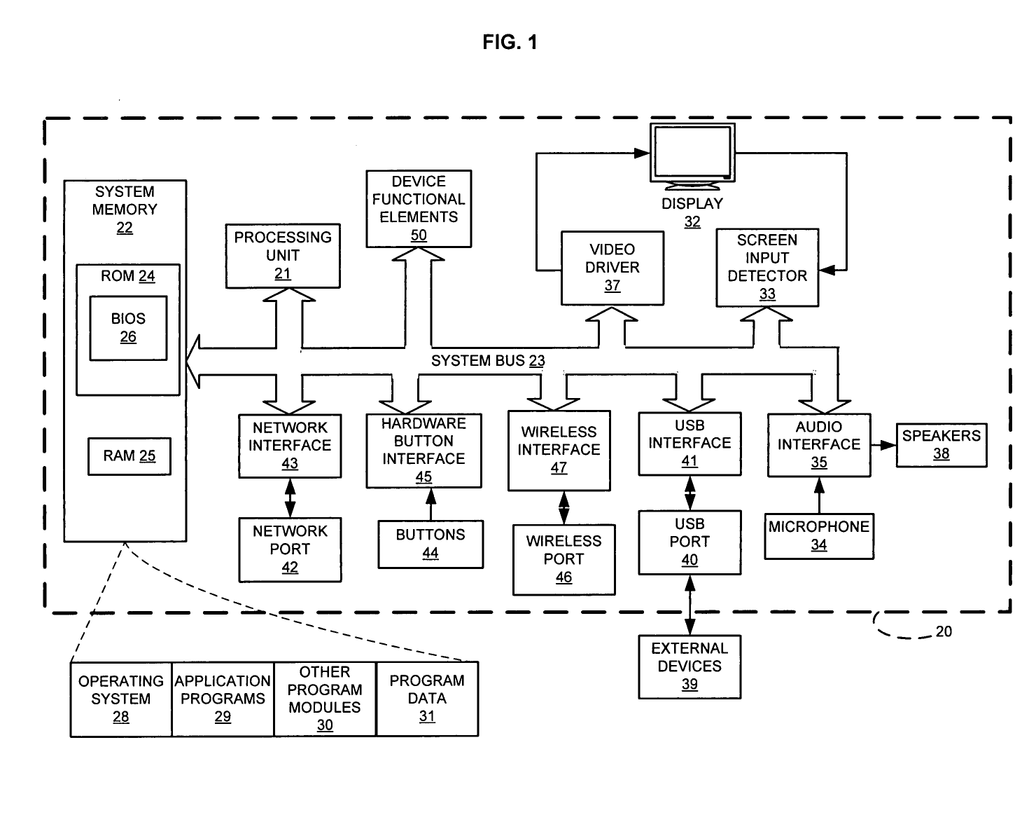

FIG. 1 and the following discussion are intended to provide a brief, general description of an environment in which embodiments may be implemented. FIG. 1 illustrates an exemplary system that includes a thin computing device 20 of an electronic device that also includes device functional element 50. For example, the electronic device may include any item having electrical and/or electronic components playing a role in a functionality of the item, such as a limited resource computing device, a digital camera, a cell phone, a printer, a refrigerator, a car, and an airplane. The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer information between sub-components within the thin computing device 20, such as during start-up, is stored in the ROM 24. A number of program modules may be stored in the ROM 24 and/or RAM 25, including an operating system 28, one or more application programs 29, other program modules 30 and program data 31.

A user may enter commands and information into the computing device 20 through input devices, such as a number of switches and buttons, illustrated as hardware buttons 44, connected to the system via a suitable interface 45. Input devices may further include a touch-sensitive display screen 32 with suitable input detection circuitry 33). The output circuitry of the touch-sensitive display 32 is connected to the system bus 23 via a video driver 37. Other input devices may include a microphone 34 connected through a suitable audio interface 35, and a physical hardware keyboard (not shown). In addition to the display 32, the computing device 20 may include other peripheral output devices, such as at least one speaker 38.

Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. The computing device 20 may further include or be capable of connecting to a flash card memory (not shown) through an appropriate connection port (not shown). The computing device 20 may further include or be capable of connecting with a network through a network port 42 and network interface 43, and through wireless port 46 and corresponding wireless interface 47 may be provided to facilitate communication with other peripheral devices, including other computers, printers, and so on (not shown). It will be appreciated that the various components and connections shown are exemplary and other components and means of establishing communications links may be used.

The computing device 20 may be primarily designed to include a user interface having a character, key-based, other user data input via the touch sensitive display 32 using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and is coupled with the system bus 23 through an interface (not shown). The functional element may typically perform a single well-defined task with little or no user configuration or setup, such as a refrigerator keeping food cold, a cell phone connecting with an appropriate tower and transceiving voice or data information, and a camera capturing and saving an image.

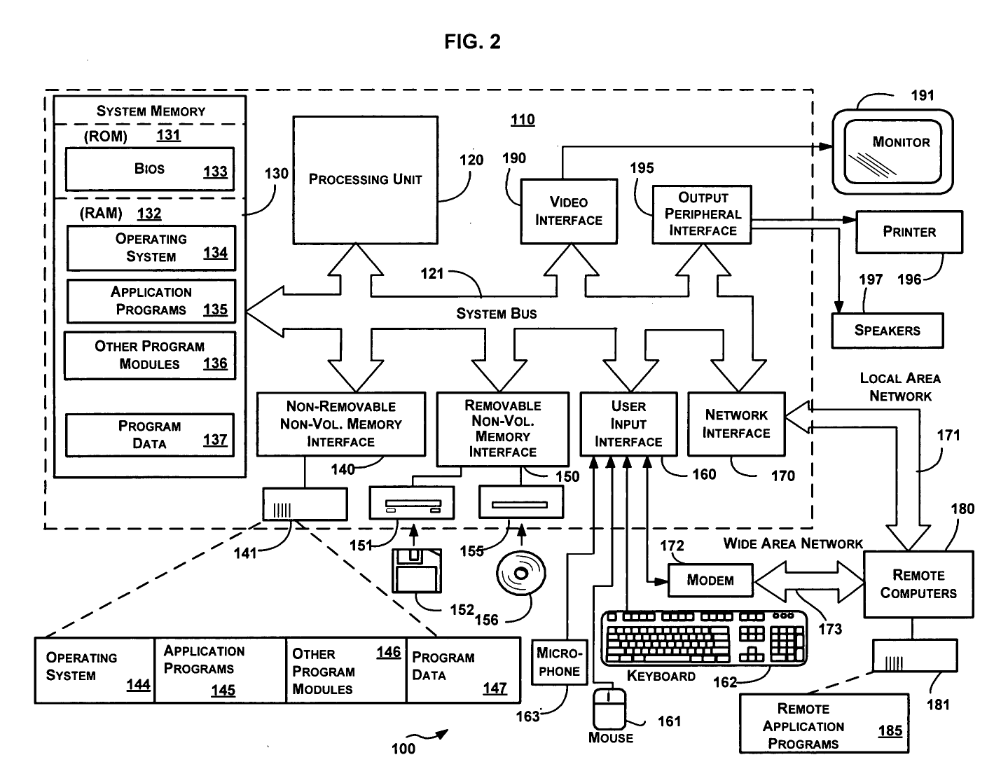

FIG. 2 illustrates another exemplary system on which embodiments of may be implemented. FIG. 2 illustrates an electronic device that may correspond in whole or part to a general-purpose computing device, shown as a computer 100. Components of the computer 100 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computer 100 typically includes a variety of computer-readable media. Computer-readable media can be any available media that can be accessed by the computer 100 and include both volatile and nonvolatile media, removable and non-removable media. By way of example, and not limitation, computer-readable media may include computer storage media and communications media. Computer storage media includes both volatile and nonvolatile, removable and non-removable media implemented in any method or technology for storage of information such as computer-readable instructions, data structures, program modules, or other data. Computer storage media include, but are not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computer 100. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media such as a wired network and a direct-wired connection and wireless media such as acoustic, RF, optical, and infrared media. Combinations of the any of the above should also be included within the scope of computer-readable media.

The system memory 130 includes computer storage media in the form of volatile and nonvolatile memory such as ROM 131 and RAM 132. A basic input/output system (BIOS) 133, containing the basic routines that help to transfer information between elements within the computer 100, such as during start-up, is typically stored in ROM 131. RAM 132 typically contains data and program modules that are immediately accessible to or presently being operated on by processing unit 120. By way of example, and not limitation, FIG. 2 illustrates an operating system 144, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” are well known in the art.

The computer 100 may also include other removable/non-removable, volatile/nonvolatile computer storage media. By way of example only, FIG. 2 illustrates a non-removable non-volatile memory interface (hard disk interface) 140 that reads from and writes to non-removable, nonvolatile magnetic media, a magnetic disk drive 151 that reads from and writes to a removable, nonvolatile magnetic disk 152, and an optical disk drive 155 that reads from and writes to a removable, nonvolatile optical disk 156 such as a CD ROM. Other removable/nonremovable, volatile/nonvolatile computer storage media that can be used in the exemplary operating environment include, but are not limited to, magnetic tape cassettes, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable memory interface, such as interface 150.

The drives and their associated computer storage media discussed above and illustrated in FIG. 2 provide storage of computer-readable instructions, data structures, program modules, and other data for the computer 100. In FIG. 2, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies. A user may enter commands and information into the computer 100 through input devices such as a microphone 163, keyboard 162 and pointing device 161, commonly referred to as a mouse, trackball, or touch pad. Other input devices (not shown) may include a joystick, game pad, satellite dish, and scanner. These and other input devices are often connected to the processing unit 120 through a user input interface 160 that is coupled to the system bus, but may be connected by other interface and bus structures, such as a parallel port, game port, or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 100, although only a memory storage device 181 has been illustrated in FIG. 2. The logical connections depicted in FIG. 2 include a local area network (LAN) 171 and a wide area network (WAN) 173, but may also include other networks such as a personal area network (PAN) (not shown). Such networking environments are commonplace in offices, enterprise-wide computer networks, intranets, and the Internet.

When used in a LAN networking environment, the computer 100 is connected to the LAN 171 through a network interface or adapter 170. When used in a WAN networking environment, the computer 100 typically includes a modem 172 or other means for establishing communications over the WAN 173, such as the Internet. The modem 172, which may be internal or external, may be connected to the system bus 121 via the user input interface 160, or via another appropriate mechanism. In a networked environment, program modules depicted relative to the computer 100, or portions thereof, may be stored in a remote memory storage device. By way of example, and not limitation, FIG. 2 illustrates remote application programs 185 as residing on memory device 181. It will be appreciated that the network connections shown are exemplary and other means of establishing a communications link between the computers may be used.

In the description that follows, embodiments will be described with reference to acts and symbolic representations of operations that are performed by one or more computing devices, such a computing device 20 of FIG. 1 and/or computer 100 of FIG. 2, unless indicated otherwise. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

FIGS. 1 and 2 illustrate an example of a suitable environment on which embodiments may be implemented. The computing device 20 of FIG. 1 and/or computer 100 of FIG. 2 are only examples of a suitable environment and are not intended to suggest any limitation as to the scope of use or functionality of an embodiment. Neither should the environment be interpreted as having any dependency or requirement relating to any one or combination of components illustrated in an exemplary operating environment.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, server computers, hand-held or laptop devices, personal digital assistants, multiprocessor systems, microprocessor-based systems, set top boxes, programmable consumer electronics, network PCs, minicomputers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in distributed computing environments where tasks are performed by remote processing devices that are linked through a communications network. In a distributed computing environment, program modules may be located in both local and remote computer storage media including memory storage devices.

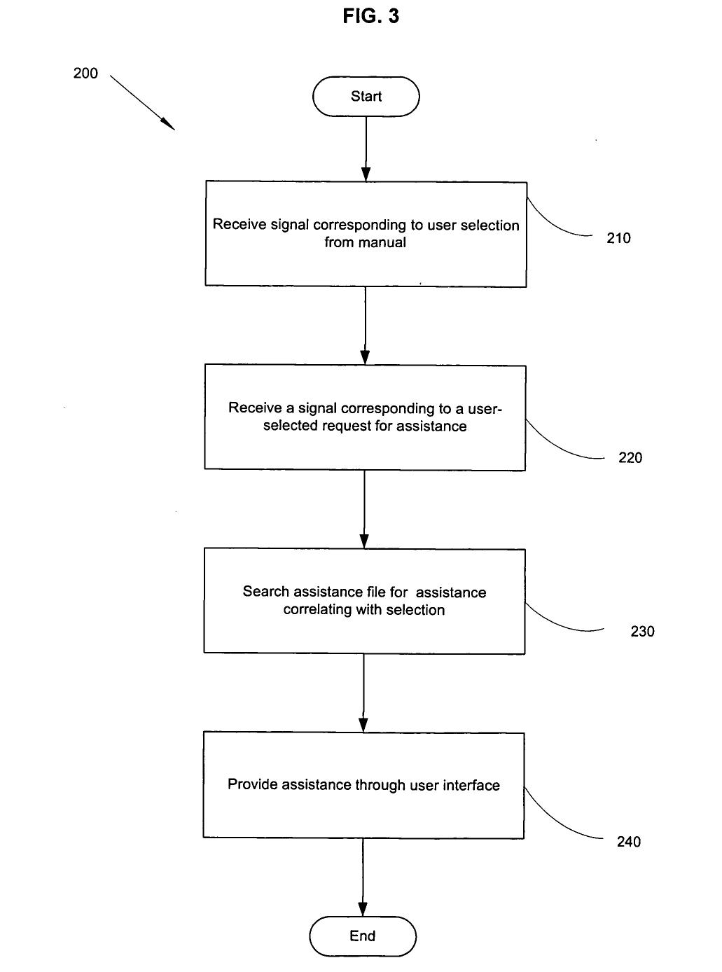

FIG. 3 is a flow diagram illustrating an exemplary process 200. After a start block, the process moves to block 210. At block 210, a signal corresponding to a user-selected portion of a manual related to an aspect of an electronic device is received. The signal may be received by a component of the electronic device. The aspect of the electronic device may be substantially anything related in any manner to the electronic device for which a user might desire assistance, such as a feature of the device, an element of the device, and a process associated with the device. The element may include a button, which may be a tangible button.

In an embodiment, the manual includes a user interface functionally separate from the electronic device. In further embodiments, the manual includes a content associated with the electronic device, and the electronic device may include a computing device, such as a personal computer and a server, a limited resource computing device, an appliance, a pervasive computing device, and a digital appliance. By way of further example, such computing devices may include a PDA, cell phone, Blackberry appliance, on-board computing device in a car, boat, aircraft, X-Box, home gateway, set-top box, point-of-sale terminal, digital camera, TiVo, and an automated teller machine.

At block 220, a signal corresponding to a user-selected request for assistance is received. The assistance may include any request related to the user-selected portion of the manual, such as “show me,” “demonstrate,” and “guide me.”

At block 230, an assistance file is searched for assistance correlating to the user-selected portion of the manual for the electronic device. The searching may be automatically performed in response to receiving the signal at block 210. The searching may include searching an assistance file stored in the electronic device.

At block 240, an assistance correlating to the user-selected portion of the manual is provided through a user interface of the electronic device different from the manual. In an embodiment, the assistance provided may include assistance with a physical element of the device, such as blinking a light associated with the physical element. The light may include a light emitting device. The provided assistance may include guidance through a process associated with the aspect of the device, a description of the aspect of the device, a showing how the aspect of the device works, and an interactive tutorial. The assistance may be provided in any manner, for example, such as a visual presentation, an audio presentation, a spoken presentation, and/or a tactile presentation.

In an embodiment, the user interface may include a visual display, a graphical display, and a graphical user interface. The user interface may include an audio display, such as an acoustic speaker. Further, the user interface may include a tactile interface, such as a vibrating component. The process then proceeds to a stop block.

In an embodiment, the process 200 may be considered to be an electronic device assistance manager. A further embodiment includes a computer-readable media containing computer instructions which, when run on a computer, cause the computer to perform the process 200. The computer-readable media may include a computer storage media, which may be carried by a computer readable carrier, such as a floppy disk. Alternatively, the computer-readable media may include a communications media.

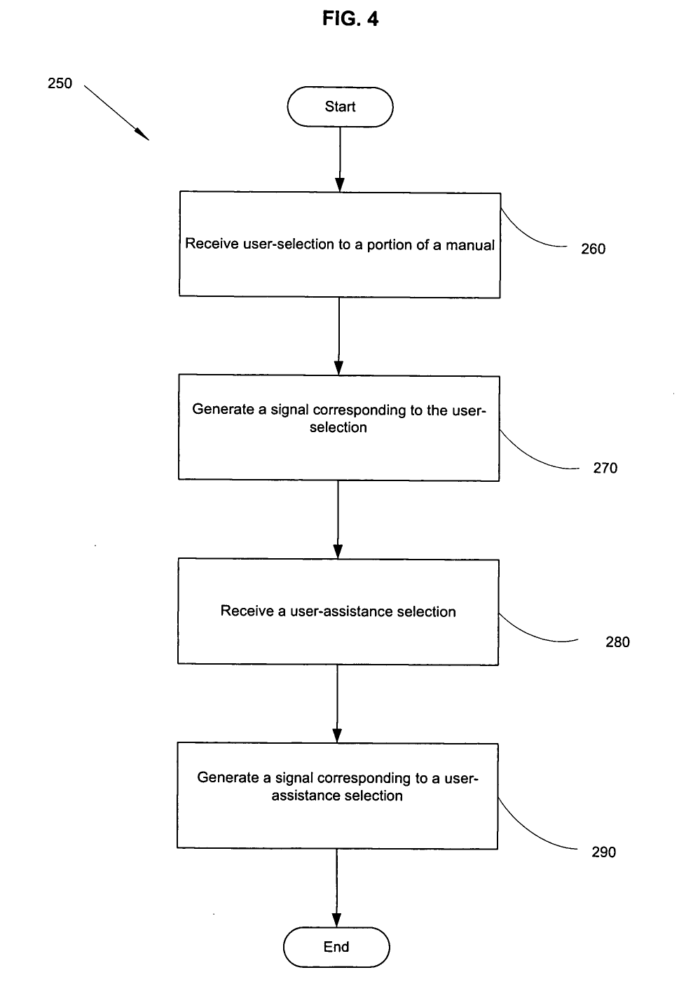

FIG. 4 is a flow diagram illustrating an exemplary process 250. After a start block, the process moves to block 260. At block 260, a user selection to a portion of a manual related to an aspect of an electronic device is received. The user selection may be received in any manner, such as recognizing a user touch to the portion of the manual, recognizing a user body part having an orientation with respect to the portion of the manual, such as an eye or finger, recognizing a user created sound, recognizing a user spoken word, and recognizing a user spoken phrase. The user body part orientation may include a static orientation; for example, a finger pointed at the portion of the manual, and an eye looking at the portion of the manual. Further, the user body part orientation may include a dynamic orientation, such as gesture or movement; for example, a sweeping movement of a finger tip with respect to the portion of the manual. The user selection is received in a user interface that is not part of the electronic device. The user-selected portion of the manual may include at least a portion of a page, a word, a picture, a figure, and a reference to a function of the device.

At block 270, a signal corresponding to the user-selected portion of the manual related to an aspect of the device is generated.

The manual may include a content related to the device. The manual may include anything related to or associated with the electronic device, such as instructions and information. The manual may include a tangible manual, such as a paper manual. The manual may include an e-paper manual. The manual may include an intangible manual, for example, such as a manual called from a storage media. The storage media may be called from a storage media of the electronic device and a storage media of the manual itself. Alternatively, the manual may be received from a remote device, such as a manual received from a server, for example a Web server, and received over a network, for example the Internet. The manual may include streaming images, such as streaming picture images and animated images. The manual may include an audio stream, such as a voice stream.

At block 280, a user-assistance selection is received. The selection may be received in any manner, includes those by which the user-selection is received at block 260. In addition, the user-assistance selection may be received at one or more buttons having defined function, such as “show me,” “demonstrate,” and “guide me.” At block 290, a signal corresponding to the user-assistance selection is generated. The process then proceeds to a stop block.

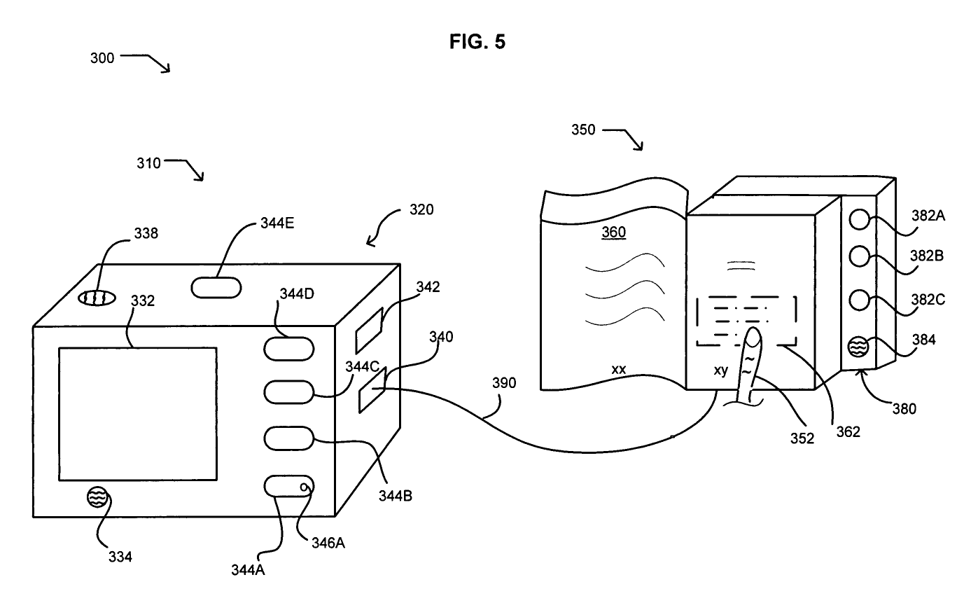

FIG. 5 illustrates an exemplary system 300 in which embodiments may be implemented. The system 300 includes a digital camera 310 and a manual 350 related to the camera. The digital camera 310 includes a computing device (not shown), such as the thin computing device 20 described in conjunction with FIG. 1. The digital camera 310 also includes a plurality of user interfaces 320. The user interfaces 320 includes a display 332 operable to provide a display. In alternative embodiments, the display 332 may provide a visual display, and a graphical display. In a further embodiment, the display 332 may include a touch screen functionality operable to accept a user input. The user interfaces 320 of the camera 310 also includes a microphone 334, a speaker 338, and a plurality of tangible buttons 344A-344E. One or more of the tangible buttons may include a light emitter, such as a light emitting device 346A. Further, one of more of the tangible buttons 344A-344E may include a vibrator operable to provide a tactile display. The display 332 and the tangible buttons 344A-344E may have any functionality appropriate to the digital camera. For example, button 344E may be assigned to operate a device element, such as a shutter function. Button 344A may be assigned an “enter” function, and buttons 344B and 344C may be respectively assigned a scroll up and scroll down function relative to a menu displayed on the display 332. Button 344D may be assigned to operate another device element, such as a lens zoom function.

The digital camera 310 further includes a USB port 340, and a network port 342. The digital camera 310 also includes a system memory (not shown), such as the system memory 22 of the thin computing device 20 of FIG. 1. The system memory includes saved operating systems and programs necessary to operate the digital camera 310, and also includes an assistance file. The assistance file includes information intended to help a user in response to user-selected requests, the requests being selected in response to portions of the manual 350. The assistance file includes operability to provide assistance, such as advice and instructions, through a user interface of the digital camera 310, such as the tangible buttons 344A-344E, the display 332, and the speaker 338. In another embodiment, the assistance file includes operability to provide interactive assistance with additional user inputs being received through the camera user interfaces 320. In an embodiment, the provided assistance may include any type of presentation, such as a visual presentation, an audio presentation, a spoken presentation, a tactile presentation, and a combination of two or more of the foregoing presentation modes.

A representative embodiment of the manual 350 illustrated in FIG. 5 includes a content display 360 that presents a content of the manual to assist a user, and an electronic interface 380. The manual 350 is coupled with the digital camera 310 by a wire link 390. In an alternative embodiment, they may be coupled by a wireless link (not shown). In the illustrated representative embodiment, the manual 350 includes a tangible manual, such as a paper manual. The content display 360 includes a plurality of touch sensitive pages, two of which are illustrated as pages XX and XY. The content display 360 of FIG. 5 illustrating two open pages of a physical or tangible manual is representative of any type of display. The content of the pages may include assistance, such as information and instructions, related to the digital camera 310. The content may be called from a storage. The storage may be associated with any device, including the manual 350 and the digital camera 310. The manual 350 may be provided by an original equipment manufacturer of the camera 310, or it may be provided by a third party.

In another embodiment, the manual may have an intangible form, and include a display other than the display 332 of the digital camera 310. In addition to the open manual or book configuration illustrated in FIG. 5, the content display 360 may include any display, on a surface plane or otherwise, operable to display static images and/or image streams related to providing a content of a manual. In another embodiment, the manual may include an e-paper manual. In a further embodiment, the manual may include operability to provide content audibly, for example by using a speaker associated with the manual (not shown). In other embodiments, the manual may include operability to provide content using a streaming image or video display, a static image display, and/or an audio display.

The manual user interface 380 includes operability to receive a user-selection to the content display 360 and a user-selection to an assistance menu, illustrated as the buttons 382A-382C, and microphone 384. The manual user interface 380 is also operable to generate appropriate signals in response to the user selections, and to provide those signals to the digital camera 310. A portion of the user interface 380 includes a correlation module operable to correlate a user-selected portion of a manual page with an aspect of the digital camera 310. Another portion of the user interface includes buttons 382A-382C, and microphone 384. The buttons 382A-382C may be described as a menu and configured to receive a user-assistance selection. The buttons may be appropriately labeled, such as “show me,” “demonstrate,” and “guide me” respectively.

In operation, a user browses through the content display 360 of the manual 350. If the user is interested in receiving assistance related to a displayed portion 362 of the manual content related to an aspect of the digital camera 310, the user selects the displayed portion. In an embodiment illustrated in FIG. 5, the manual 350 receives a user selection of the displayed portion 362 of the manual content by receiving a touch by a user's finger tip to the displayed portion. In other embodiments, the manual 350 receives a user selection of the displayed portion 362 of the manual content in any manner, for example, receiving a user body part orientation with respect to the portion of the manual, such as a finger tip 352 pointed toward the displayed portion, or an eye directed toward the displayed portion (not shown). Alternatively, the manual 350 may receive a user selection by receiving at the microphone 384 a user created sound, a user spoken word, and a user spoken phrase. For example, a user may have selected a displayed portion 362 related to deleting saved images from a memory of the digital camera 310.

In response to the received user-selection to the displayed portion 362 of the manual, the user interface 380 generates a signal corresponding to the user-selection. The signal is communicated from the manual 350 to the digital camera 310 by the wire link 390.

In an alternative embodiment, the user additionally selects an assistance from a menu of assistance modes presented by the buttons 382A-382C, which are respectively labeled as “show me,” “demonstrate,” and “guide me.” Continuing the above example where the selected displayed portion 362 related to deleting saved images, a user may have selected button 382A, “show me.” In response to the received user-selected request for “show me” assistance, the user interface 380 generates a signal corresponding to “show me” assistance request. The signal is communicated between the manual 350 and the digital camera 310 by the wire link 390. Alternatively, the signal may be communicated between the manual 350 and the digital camera 310 by a wireless link (not shown).

The digital camera 310 receives the signals from the manual 350 communicated over the wire link 390. In response to the received signal corresponding to a user-selected portion 362 of the manual, an electronic device assistance manager running on the computing device (not shown) searches an assistance file stored in a memory of the computing device for an assistance correlating with the user-selected portion of the manual. The assistance file includes assistance content related to the electronic device, which includes a configuration for providing assistance through the user interfaces 320 of the digital camera 310. With reference to the above example where the selected portion 362 of the manual relates to deleting saved images, the assistance manager searches the assistance file for assistance content related to deleting saved images. The assistance content includes using the user interfaces 320 of the digital camera 310 to provide assistance.

In the alternative embodiment illustrated above where the user further selected “show me” as the type of assistance desired, the electronic device assistance manager further searches the assistance file for an assistance both correlating with the user-selected portion of the manual and the “show me” assistance request.

In response to the search of the assistance file, the digital camera 310 provides assistance correlating to the user-selected request for assistance through at least one the user interfaces 320 of the digital camera. For example, the assistance may include providing in the display 332 a demonstrative visual presentation of the menu used to delete saved images, and a representation of a user movement through the menu to delete saved images. The assistance may also provide a voice track through the speaker 338 that describe the deletion process, the voice track being coordinated with the visual presentation in the display 332. The assistance may further include flashing the light emitter 346A as appropriate to indicate when the button 344A should be pressed by a user. Alternatively, the provided assistance may include an assistance that guides a user through the actually steps to delete a user-selected saved image.

In another embodiment, the digital camera 310 and the manual 350 jointly present assistance correlating to the selected portion 362 of the manual. The assistance may be jointly presented, allocated, selected, and/or coordinated in any manner. For example, a manner of jointly presenting the assistance may depend in part on the relative richness of the digital camera 310 and the manual 350, and their respective user interfaces. Continuing with this example, assume the manual 350 of FIG. 5 includes a speaker (not shown) having a better quality than the speaker 338 of the digital camera 310, and the digital camera includes a microphone 334 having a better quality than the microphone 380 of the manual 350. The process of providing an assistance corresponding to the selected portion 362 of the manual in this embodiment may include receiving user input related to the selected portion 362 of the manual 350 through the microphone 334 of the digital camera 310. For example, the manual 350 may detect a touch of the user finger 352 to the portion 362 as a selection and generate a corresponding signal. The microphone 334 of the camera 310 may detect a user speaking words “show me” and generate a corresponding signal. The data in these two signals may be combined, forming a signal corresponding to a selected portion of the manual 350 related to an aspect of the digital camera 310. Continuing with this example, the process of providing an assistance correlating to the selected portion of the manual may include jointly providing an assistance through user interfaces of both the manual 350 and the digital camera 310. For example, a joint presentation of the assistance may include a providing a streaming visual presentation using the visual display 332 of the camera 310 and displaying a new page (not shown) of the manual other than the page containing the selected portion 362.

A further embodiment relates to providing assistance with an item having one or more aspects for which assistance may be desired. However, the item does not include an electronic device, or if it does include an electronic device, the electronic device only includes a very a thin computing device or very limited or non-existent user interfaces. The further embodiment includes a smart device (not shown) and a manual for an item, such as the manual 350. The smart device includes a computing device, such as the thin computing device 20 described in conjunction with FIG. 1. The thin computing device includes a plurality of user interfaces, for example, a plurality of user interfaces substantially similar to the user interfaces 320 of the digital camera 310, such as a visual display, a microphone, a speaker, and a plurality of tangible buttons. In addition, one or more of the tangible buttons may include a light emitter, such as a light emitting device, and a vibrator operable to provide a tactile display.

An embodiment of the smart device includes a physical object having a configuration providing a meaningfully association with aspects of the item. In an embodiment, the association may be physical, with the smart device being physically overlaid or applied to the item such that one or more portions of the smart device user interfaces are respectively proximate to and visually associable with the one or more aspects of the item. One or more of the user interfaces may be respectively configured to be positioned proximate to and visually associable with the one or more aspects of the item. The smart device may further include a USB port, a network port, and a wireless port.

The computing device includes a system memory, such as the system memory 22 of the thin computing device 20 of FIG. 1. The system memory includes saved operating systems and programs necessary to operate the smart device, an assistance manager, such as the process 200 described in conjunction with FIG. 3, and an assistance file. The assistance file includes a body of information intended to help a user in response to a plurality of user-selected requests related to the item, the requests being selected in response to the manual 350 as described above. The assistance file includes operability to provide assistance, such as advice and instructions related to the item, through the user interfaces of the smart device. The smart device is coupled with the manual 350 using the coupler 390. Alternatively, the smart device and the manual 350 are wirelessly coupled. Wireless coupling may provide flexibility in applying the smart device to the item without requiring physical cabling between the smart device and the manual.

An example of an application of the smart device and the manual 350 includes providing assistance with a control panel for an item, such as complicated system, for example, as is present in a manufacturing operation, in electrical grid control, in a sound board of a recording studio, and in a planetarium. In an embodiment, the smart device would include openings allowing the smart device to be fitted over knobs and around dials of the control panel, and include user interfaces proximate to the openings. The user interfaces of the smart device may include LED's of various colors that can be appropriately switched on, off, or blinked, to provide an assistance correlating to the selected portion 362 of the manual 350. A user desiring assistance would select a desired assistance, and the assistance is provided using appropriate LED's and other portions of the user interfaces of the smart device. In addition, the assistance may also be provided through the user interfaces of the manual 350.

Another example of an application of the smart device and a manual, such as the manual 350, includes providing assistance with an item, such as a hotel room or an ergonomic chair. Using the hotel room as an example, smart tags may be respectively associated aspects of the hotel room by placement at locations proximate to aspects. The manual relates the hotel room, such as, for example, a hotel room guide, and portions correspond to aspects of the hotel room. The smart tags may include an electronic device, a wireless link, and a user interface, such as a switchable light source and sound generator. The manual may include user selectable content related to aspects of the hotel room, and a wireless link. For example, smart tags may be respectively placed proximate to a thermostat, a dimmer switch for a hot tub, and a switch that closes a window covering. A user wanting assistance in locating the thermostat could select a portion of the hotel room guide related to the thermostat. The hotel room guide, or manual, would receive the selection and in responsive thereto wirelessly transmit a signal activating a user interface of the smart tag proximate to the thermostat. For example, the user interface may blink a light and emit a beeping sound to attract attention to the thermostat location, thus providing assistance. Using the ergonomic chair example, smart tags may be placed at locations on or proximate to respective levers and knobs of the chair. A user wanting assistance in reclining the chair back could select a portion of the chair manual related to the chair back. The manual would receive the selection and wirelessly transmit a signal activating a user interface located on a lever adjusting a reclining function. For example, the user interface may blink a light, thus providing assistance. The smart tags may be removable from the chair.

The state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will require optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

What is claimed is:

1. A method comprising:
(a) receiving a signal corresponding to a selected portion of a manual related to an aspect of an electronic device; and
(b) providing an assistance correlating to the selected portion of the manual through a user interface of the electronic device different from the manual.

2. The method of claim 1, further comprising:
(c) searching an assistance file for the assistance correlating to the selected portion of the manual.

3. The method of claim 2, wherein searching the assistance file includes searching an assistance file stored in the electronic device.

4. The method of claim 1, wherein the providing an assistance further includes providing a visual presentation.

5. The method of claim 1, wherein the providing an assistance further includes providing an audio presentation.

6. The method of claim 1, wherein the providing an assistance further includes providing a spoken presentation.

7. The method of claim 1, wherein the providing an assistance further includes providing a tactile presentation.

8. The method of claim 1, wherein the assistance includes assistance with a physical element of the device.

9. The method of claim 8, wherein the assistance with the physical element of the device includes blinking a light emitter associated with the physical element.

10. The method of claim 1, wherein the assistance includes a guidance through a process associated with the aspect of the device.

11. The method of claim 1, wherein the assistance includes description of the aspect of the device.

12. The method of claim 1, wherein the assistance includes showing how the aspect of the device works.

13. The method of claim 1, wherein the assistance includes an interactive tutorial.

14. The method of claim 1, wherein the selected portion of a manual related to an aspect of an electronic device includes a user-selected portion of a manual related to an electronic device.

15. The method of claim 1, wherein the user interface of the electronic device includes a user interface associated with the electronic device.

16. A computer-readable media containing computer instructions which, when run on a computer, cause the computer to perform the method of claim 1.

17. The computer-readable media of claim 16 wherein the computer-readable media includes a computer storage media.

18. The computer-readable media of claim 17, wherein the computer storage media is carried by a computer readable carrier.

19. The computer-readable media of claim 16, wherein the computer-readable media includes a communications media.

20. A method comprising:
(a) receiving a signal corresponding to a selected portion of a manual related to an item having an electronic device; and
(b) providing an assistance correlating to the selected portion of the manual through a user interface associated with the electronic device and different from the manual.

21. A method comprising:
(a) receiving a signal corresponding to a selected portion of a manual related to an item; and
(b) providing an assistance correlating with the selected portion of the manual through a user interface of an electronic device associated with item.

22. The method of claim 21, wherein the assistance includes assistance with a physical element of the item.

23. The method of claim 21, wherein the user interface of the electronic device associated with the item includes a removable association with the item.

24. A system comprising:
(a) an electronic device having an electronic device user interface and including a computing device having a storage media;
(b) a manual having a manual user interface and including a content related to the electronic device, and being operable to;
(i) receive a user-selection to a portion of the manual related to an aspect of the electronic device through the manual user interface; and
(ii) generate a signal corresponding to the user-selected portion of the manual; and
(c) an electronic device assistance manager which includes instructions, that when implemented in a computing device cause the computing device to;
(i) receive the signal corresponding to a user-selected portion of the manual; and
(ii) provide an assistance correlating to the user-selected portion of the manual through the electronic device user interface.

25. The system of claim 24, wherein the electronic device assistance manager further includes an assistance file having an assistance content related to the electronic device.

26. The system of claim 24, wherein the electronic device is included in an electrical appliance and the manual includes a content associated with the electrical appliance.

27. The system of claim 24, wherein the electronic device is included in a computing device and the manual includes a content associated with the computing device.

28. The system of claim 27, wherein the computing device includes a personal computer.

29. The system of claim 24, wherein the electronic device is included in a limited resource computing device and the manual includes a content associated with the limited resource computing device.

30. The system of claim 24, wherein the electronic device is included in a pervasive computing device and the manual includes a content associated with the pervasive computing device.

31. The system of claim 24, wherein the electronic device is included in a digital appliance and the manual includes a content associated with the digital appliance.

32. The system of claim 24, wherein the manual and the electronic device are linked by a physical coupling.

33. The system of claim 24, wherein the manual and the electronic device are linked by a wireless coupling.

34. The system of claim 24, wherein the aspect of the electronic device includes a feature of the electronic device.

35. The system of claim 24, wherein the aspect of the electronic device includes a component of the electronic device.

36. The system of claim 24, wherein the aspect of the electronic device includes a button of the electronic device.

37. The system of claim 36, wherein the button includes a tangible button.

38. The system of claim 24, wherein the aspect of the electronic device includes a process associated with the electronic device.

39. The system of claim 24, wherein the manual includes information related to the device.

40. The system of claim 24, wherein the manual includes instructions related to the device.

41. The system of claim 24, wherein the electronic device user interface includes a visual display.

42. The system of claim 24, wherein the electronic device user interface includes a graphical display.

43. The system of claim 24, wherein the electronic device user interface includes a graphical user interface.

44. The system of claim 24, wherein the electronic device user interface includes an audio display.

45. The system of claim 44, wherein the audio display includes an acoustic speaker.

46. The system of claim 24, wherein the electronic device user interface includes a tactile display.

47. A system comprising:
(a) an electronic device having an electronic device user interface and including a computing device having a storage media; and
(b) an electronic device assistance manager which includes instructions, that when implement in a computing device cause the computing device to;
(i) receive a signal corresponding to a user-selected portion of a manual related to an aspect of the electronic device; and
(ii) provide an assistance correlating to the user-selected portion of the manual through the electronic device user interface.

48. A system comprising:
(a) a computing device having a user interface and a storage media;
(b) a manual having a user interface and including a content related to the computing device, and being operable to;
(i) receive a user-selection to a portion of the manual related to an aspect of the computing device through the manual user interface; and
(ii) generate a signal corresponding to the user-selected portion of the manual; and
(c) a computing device assistance manager which includes instructions, that when implement in a computing device cause the computing device to;
(i) receive the signal corresponding to a user-selected portion of the manual; and
(ii) provide an assistance correlating to the user-selected portion of the manual through the electronic device user interface.

49. A method comprising:
(a) receiving a signal corresponding to a user-selected portion of a manual related to an aspect of an electronic device, the user selection having been received by a user interface of the manual;
(b) receiving a signal corresponding to a user-selected request for assistance related to the aspect of the electronic device, the user selection having been received by the user interface of the manual;
(c) searching an assistance file for an assistance correlating to the user-selected request for assistance; and
(d) providing the assistance correlating to the user-selected request for assistance through a user interface of the electronic device.

50. The method of claim 49, wherein the signal corresponding to a user-selected request for assistance is generated in response to a user selection of an assistance mode from a menu provided by the manual.

51. A manual comprising:
(a) a content related to an electronic device;
(b) a user interface different from the electronic device and operable to receive a user-selection to a portion of the manual content; and
(c) a module operable to generate a signal corresponding to the user-selected portion of the manual.

52. The manual of claim 51, wherein operable to receive a user-selection includes operability to receive a user touch.

53. The manual of claim 51, wherein operable to receive a user-selection includes operability to receive a user body part orientation with respect to the portion of the manual.

54. The manual of claim 53, wherein the user body part is a finger.

55. The manual of claim 53, wherein the user body part is an eye.

56. The manual of claim 51, wherein operable to receive a user-selection includes operability to receive a movement of a user body part with respect to the portion of the manual.

57. The manual of claim 51, wherein operable to receive a user-selection includes operability to receive a user created sound.

58. The manual of claim 51, wherein operable to receive a user-selection includes operability to receive a user spoken word.

59. The manual of claim 51, wherein operable to receive a user-selection includes operability to receive a user spoken phrase.

60. The manual of claim 51, wherein the manual includes information related to the device.

61. The manual of claim 51, wherein the manual includes instructions related to the device.

62. The manual of claim 51, wherein the manual includes a tangible manual.

63. The manual of claim 51, wherein the tangible manual includes a paper manual.

64. The manual of claim 51, wherein the manual includes an e-paper manual.

65. The manual of claim 51, wherein the manual includes an intangible manual.

66. The manual of claim 65, wherein the intangible manual includes a manual called from a storage.

67. The manual of claim 65, wherein the intangible manual includes a manual received over the Internet.

68. The manual of claim 51, wherein the manual includes streaming images.

69. The manual of claim 51, wherein the manual includes an audio stream.

70. A manual comprising:
(a) a content related to an item having an electronic device;
(b) a user interface different from the electronic device and operable to receive a user-selection to a portion of the manual content; and
(c) a module operable to generate a signal corresponding to the user-selected portion of the manual.

71. A method comprising:
(a) receiving a user-selection to a portion of a manual having a content related to an electronic device in a user interface different from the electronic device; and
(b) generating a signal correlating to the user-selected portion of the manual content.

72. The method of claim 71, wherein the receiving the user-selection includes receiving a signal responsive to a user-selection touch to the portion of the manual.

73. The method of claim 71, wherein the receiving the user-selection includes receiving a signal responsive to a user body part having an orientation with respect to the portion of the manual.

74. The method of claim 71, wherein the receiving the user-selection includes receiving a signal responsive to a user created sound.

75. The method of claim 71, wherein the user-selected portion of the manual includes at least a portion of a page.

76. The method of claim 71, wherein the user-selected portion of the manual includes a word.

77. The method of claim 71, wherein the user-selected portion of the manual includes a picture.

78. The method of claim 71, wherein the user-selected portion of the manual includes a figure.

79. The method of claim 71, wherein the user-selected portion of the manual includes a portion of an image stream.

80. The method of claim 71, wherein the user-selected portion of the manual includes a portion of an audio stream.

81. The method of claim 71, wherein the user-selected portion of the manual includes a reference to a function of the device.

82. A method comprising:
(a) receiving a user-selection to a portion of a manual related to an electronic device through a user interface;
(b) generating a signal corresponding to the user-selected portion of the manual;
(c) receiving a user assistance selection in the user interface; and
(d) generating a signal corresponding to the user assistance selection.

83. The method of claim 82, wherein the user assistance selection is received in a user interface different from the electronic device.

84. An apparatus comprising:
(a) means for receiving a signal corresponding to a selected portion of a manual related to an aspect of an electronic device; and
(b) means for providing an assistance correlating to the selected portion of the manual through a user interface of the electronic device different from the manual.

85. The method of claim 84, further comprising:
(c) means for searching an assistance file for the assistance correlating to the selected portion of the manual.

86. An apparatus comprising:
(a) means for receiving a signal corresponding to a user-selected portion of a manual related to an aspect of an electronic device, the user selection having been received by a user interface of the manual;
(b) means for receiving a signal corresponding to a user-selected request for assistance related to the aspect of the electronic device, the user selection having been received by the user interface of the manual;
(c) means for searching an assistance file for an assistance correlating to the user-selected request for assistance; and
(d) means for providing the assistance correlating to the user-selected request for assistance through a user interface of the electronic device.

87. An apparatus comprising:
(a) means for receiving a user-selection to a portion of a manual having a content related to an electronic device in a user interface different from the electronic device; and
(b) means for generating a signal correlating to the user-selected portion of the manual content.

88. An apparatus comprising:
(a) means for receiving a user-selection to a portion of a manual related to an electronic device through a user interface;
(b) means for generating a signal corresponding to the user-selected portion of the manual;
(c) means for receiving a user assistance selection in the user interface; and
(d) means for generating a signal corresponding to the user assistance selection.
